(19) United States
(12) Patent Application Publication
(10) Pub. No.: US 2023/0333958 A1
(43) Pub. Date: Oct. 19, 2023

(54) DIAGNOSIS AND TROUBLESHOOTING OF DEVICES USING MULTIPLE LAYER ARCHITECTURE

(71) Applicant: INNOPEAK TECHNOLOGY, INC., Palo Alto, CA (US)

(72) Inventors: Weidong ZHANG, Palo Alto, CA (US); Yen-Liang KUO, Palo Alto, CA (US); Pai-Han HUANG, Palo Alto, CA (US); Mao-ter CHEN, Palo Alto, CA (US)

(21) Appl. No.: 18/343,148

(22) Filed: Jun. 28, 2023

Related U.S. Application Data
(63) Continuation of application No. PCT/US2021/065751, filed on Dec. 30, 2021.
(60) Provisional application No. 63/132,851, filed on Dec. 31, 2020.

(51) Int. Cl. G06F 11/34; G06F 11/30

(52) U.S. Cl. CPC G06F 11/3409; G06F 11/3062; G06F 11/3452

(57) ABSTRACT

Systems and methods are provided. In the method, information is obtained from a device, the information indicative of a status of the device. The information is categorized according to a multiple layer analytical architecture, where the multiple layer analytical architecture includes a first category indicative of an overall status of the device and a second category indicative of a status of a particular component, application, operation, or feature. Multiple modes of analyses are performed on at least a subset of the categorized information to troubleshoot or diagnose an anomalous behavior of the device.

### CROSS-REFERENCE OF RELATED APPLICATIONS

This application is continuation of International Patent Application No. PCT/US2021/065751, filed Dec. 30, 2021, which claims priority to U.S. Provisional Application No. 63/132,851, filed Dec. 31, 2020, the entire disclosures of which are incorporated herein or by reference.

### BACKGROUND

A number of computing devices have been increasing at ever accelerating rates. In 2021, for example, nearly 15 billion mobile devices alone are operating worldwide. This number is predicted to reach over 18 billion by 2025. Meanwhile, a number of users of mobile phones is over 7 billion, which amounts to nearly 90 percent of the world's population using a mobile phone. Concurrent with the increase in mobile devices is an increased demand and urgency to troubleshoot and resolve issues, such as hardware, software, and/or application issues, with such mobile devices. Currently, in Europe and North America, over half of mobile devices returned have been designated as “No Trouble Found,” indicating that no problems were uncovered within the mobile devices themselves. Additionally, even when problems are diagnosed, the diagnoses often do not resolve the underlying issues of the mobile devices.

### BRIEF DESCRIPTION OF THE DRAWINGS

The present disclosure, in accordance with one or more various examples, is described in detail with reference to the following figures. The figures are provided for purposes of illustration only and merely depict typical or example examples. These illustrative examples are mentioned not to limit or define the disclosure, but to provide examples to aid understanding thereof. Additional examples are discussed in the Detailed Description, and further description is provided there.

FIG. 1 is an example illustration of a computing system that obtains information from a device, and categorizes or organizes the information according to a multi-layer analysis architecture, in order to diagnose or troubleshoot anomalous behavior of the device, according to examples described in the present disclosure.

FIGS. 2-6 are example illustrations of different categories of information, representing different layers of the analysis architecture, according to examples described in the present disclosure.

FIG. 7 is an example illustration of the computing system that outputs information or a result of an analysis of the device, according to examples described in the present disclosure.

FIG. 8 is an example illustration of the computing system that performs downstream analysis, predictions, troubleshooting, and/or diagnosis of an anomalous behavior of a device, according to examples described in the present disclosure.

FIG. 9 is an example flowchart, illustrating how a computing component obtains, categorizes, and analyzes information, within a multi-layer analysis architecture, according to examples described in the present disclosure.

FIG. 10 is an example computing component that may be used to implement various features of examples described in the present disclosure.

The figures are not exhaustive and do not limit the present disclosure to the precise form disclosed.

### DETAILED DESCRIPTION

In order to diagnose and troubleshoot issues or problems occurring in devices, such as mobile devices, information such as battery capacity or consumption, signal strength, dropped calls, temperature, and/or processes running of the devices may be obtained and analyzed. Traditionally, the obtaining of such different categories of information or different modes of operation is not only limited, but also isolated. Thus, for example, different categories of information, such as battery capacity or consumption compared to temperature, may be obtained separately from other categories, and the analysis of such different categories may be isolated from one another. Not only is such a non-unified approach largely insufficient to resolve device problems, but it also causes inefficient deployment and construction of infrastructure, such as hardware and/or software, in order to obtain the information. For example, separate infrastructure may be constructed, deployed, and maintained to collect each category of information, and each category of information may not be linked. Therefore, analysis of device behavior not only relies on limited amount of information for each category, but also is restricted to testing a single factor or hypothesis rather than a combination of factors or hypotheses.

Examples described herein address these challenges by implementing a computing component, such as a server, that obtains or collects different categories or layers of information from devices. In some examples, the different categories of information may be associated with or refer to distinct modes of operation or analysis, distinct hardware components, distinct software components, distinct processes, distinct applications and/or distinct levels of granularity (e.g., on a level of the entire device, or specific portions of the device). Therefore, troubleshooting and/or diagnosis of issues or problems in devices may be augmented with different categories of information, rather than a single category of information. Such an approach may be especially valuable because device failures may often be attributed to a multitude of reasons rather than a single reason. In addition, even if a device failure is attributed to a single reason, the diagnosis and troubleshooting of the device failure may be done at one time, rather than on separate occasions, because the information of different categories has been collected together rather than separately.

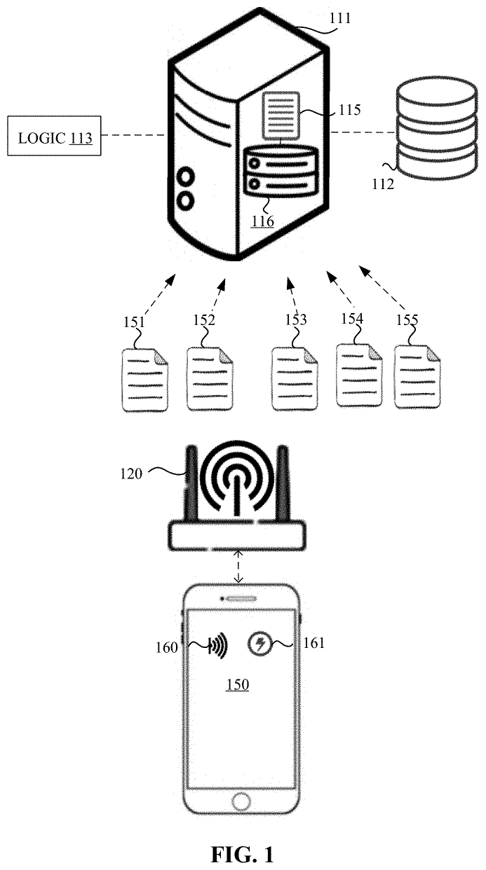

FIG. 1 is an exemplary illustration of computing system 110 including a computing component 111. The computing component 111 may include a plurality of processors and/or servers. For example, the computing component 111 may include a cluster that operates on a platform which performs functions such as data analysis and/or storage. The computing component 111 may receive or upload (hereinafter “receive”) information obtained from a device 150. Although only a single device 150 is illustrated for simplicity, the computing component 111 may obtain information from multiple devices. The information may include logs, metrics, and/or parameters regarding the operation of the device 150, hardware components, and/or applications thereof. For example, as alluded to above, the information may encompass or be indicative of different categories, such as distinct modes of operation or analysis, distinct hardware components, distinct software components, distinct processes, distinct applications and/or distinct levels of granularity (e.g., on a level of the entire device, or specific portions of the device). As one non-limiting example, for distinct modes of analysis, the information may include, and be separated or organized according to, first information 151 regarding an entirety of the device 150, second information 152 regarding individual components of the device 150, third information 153 regarding different operations being performed on the device 150, fourth information 154 regarding individual applications and processes on the device 150, and/or fifth information 155 regarding different settings on the device 150. The separation or organization may correspond to separate layers of an analytical architecture. The information may include metrics, parameters, and/or indicators from the device 150 regarding operation of the device 150. The information may be already processed from raw information obtained from the device 150. For example, the processing may include certain arithmetic and/or processing operations. For example, the information may be a result of accumulating a subset (e.g., a portion or an entirety) of the metrics, parameters, and/or indicators, or taking a minimum, maximum, mean, median, or mode of the subset. The processing may additionally or alternatively include cleansing, reformatting, and/or enrichment.

The computing component 111 may include one or more hardware processors and logic 113 that implements instructions to carry out the functions of the computing component 111. The computing component 111 may include one or more physical devices or servers, or cloud servers on which services or microservices run. The computing component 111 may store, in a database 112, details regarding the device 150, and the information received. The database 112 may be indexed by an index 115 to categorize or classify the information stored in the database 112. For example, the database 112 may include information of the device 150, such as any of the first information 151, the second information 152, the third information 153, the fourth information 154, and/or the fifth information 155. The information may include performance metrics, attributes, or parameters. In some examples, the computing component 111 may cache at least a portion of the data stored in the database 112 in a cache 116, which may be part of an internal memory structure within the computing component 111. For example, the computing component 111 may cache any of the information within the database 112 that may be frequently accessed, referenced, or analyzed, and/or may be frequently changing (e.g., having a higher than a threshold standard deviation and/or higher than a threshold variability with respect to time). Such data may include a portion of the information from the device 150 that frequently updates, and/or is prioritized. As alluded to previously, the prioritized information may include information of or associated with the device 150 that is most recent, and/or attributed to among highest levels or proportions of energy consumption or computing resource utilization.

In some examples, the device 150 may include, but is not limited to, a mobile device. Such a device may encompass a mobile phone, smartphone, tablet, personal digital assistance (PDA), desktop, laptop, Internet of Things (IoT) device, plug and play (PnP) device, processors such as central processing units (CPUs), graphics processing units (GPUs), field-programmable gate arrays (FPGAs), application-specific integrated circuits (ASICs), or system-on-chips (SoCs). The device 150 may exchange data with other devices, via a network. The connection to the network may be established via one or more network devices 120 to a network, or be in an ad-hoc fashion without a network device. The network devices 120 may include access points, routers, switches, and/or gateways.

One or more sensors and/or meters (hereinafter “sensors” collectively) on the device 150 may, in conjunction with one or more daemon processes, obtain the information (e.g., the first information 151, the second information 152, the third information 153, the fourth information 154, and the fifth information 155) from the device 150. For example, a sensor 160 may, in conjunction with a daemon process 161 implanted within the device 150, obtain the information from the device 150. The computing component 111 may then upload or obtain the information from the daemon process 161. Alternatively, the daemon process 161 may upload the information to the computing component 111. In some examples, the computing component 111 may further categorize or organize the information according to the previously described architecture layer having first information 151 through fifth information 155. In other words, when the computing component 111 receives the information from the daemon process 161, the information may not be organized or categorized according to the first information 151 through fifth information 155. The information may be stored in the database 112, and at least a portion of the information may be cached in the cache 116.

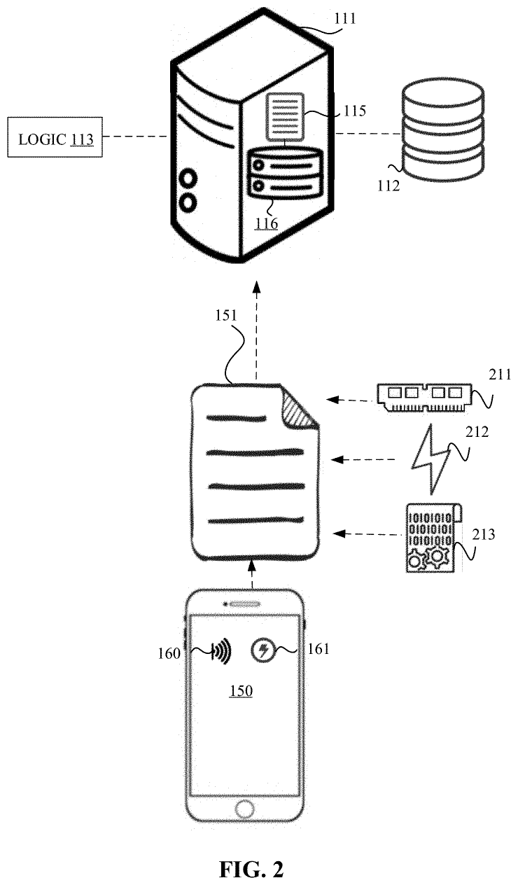

FIG. 2 elaborates upon the first information 151, which may be on a scale of an entirety of the device 150. For example, the first information 151 may include performance metrics such as computing resources (e.g., overall memory such as solid state memory, storage, processing power, or electrical power) utilized or consumed, amount of data transmitted, received, or exchanged, frame or packet sizes transmitted, received, or exchanged, number of frames or packets transmitted, received, or exchanged, and/or frequency of data such as frames or packets transmitted, received, or exchanged. The first information 151 may be aggregated over a specific time period, such as, over a 24-hour time period, an hourly time period, or a weekly time period. In FIG. 2, the first information 151 may include information regarding memory utilization 211 (e.g., a total amount of solid state memory or other memory available, utilized, and/or reserved), information regarding electricity utilization 212, and/or information regarding data packets or frames 213, for example. In some examples, the first information 151 may be obtained based on an aggregate or summation of information from all processes, operations, and/or components within the device 150. The first information 151 may provide an overall indication regarding a health and/or status of the device 150.

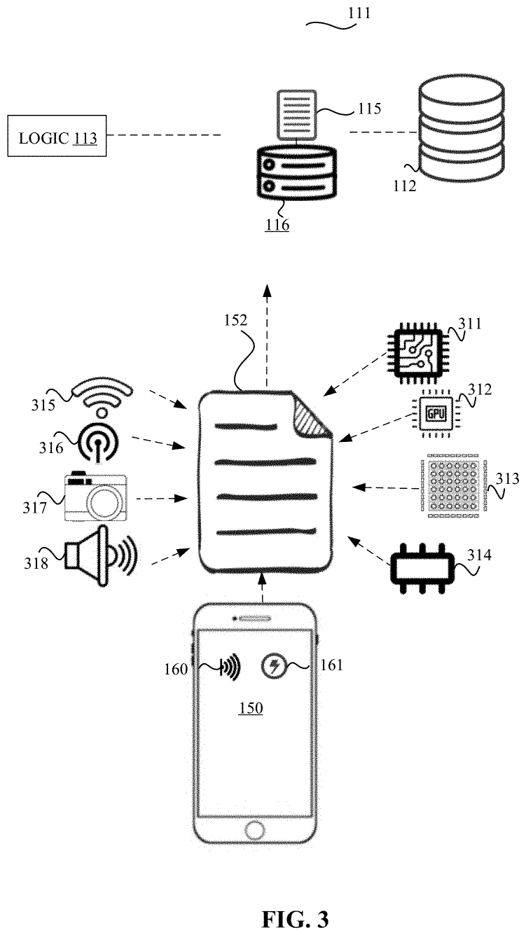

FIG. 3 elaborates upon the second information 152, which may include information regarding individual components of the device 150. In some examples, the second information 152 may include information from, regarding, or associated with particular processors or components such as information from a CPU 311, information from a GPU 312, information from an FPGA 313, information from a particular memory component such as Double Data Rate (DDR) Synchronous Dynamic Random Access memory (SDRAM) 314, information from a Wireless Fidelity (WiFi) component 315, information from a cellular component 316, information from a camera 317, information from a speaker 318. For example, the second information 152 may include resource allocation and/or power allocation across different components of the device 150, performance metrics of or indicative of energy and/or data utilization and/or available energy of particular processors or components, similar or analogous to the performance metrics described with respect to the first information 151. The second information 152 may be aggregated over a specific time period, such as, over a 24-hour time period, an hourly time period, or a weekly time period.

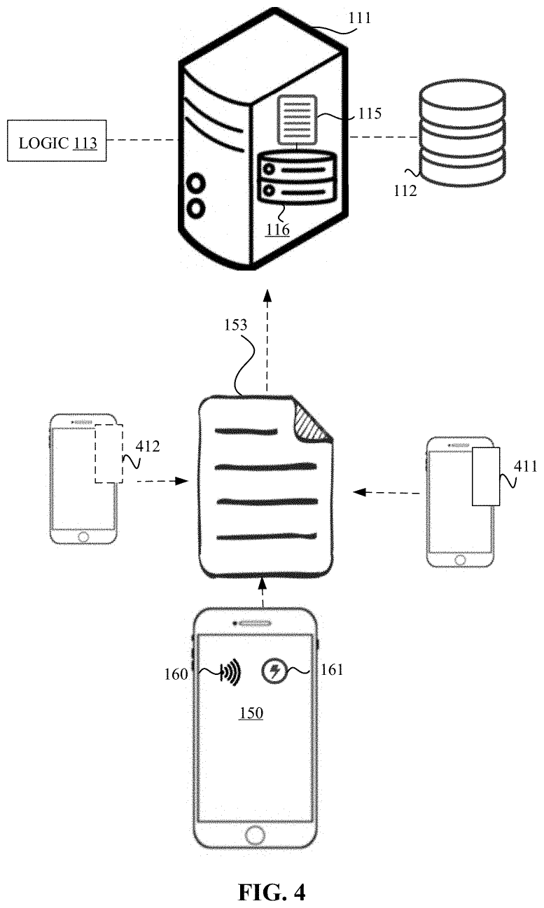

FIG. 4 elaborates upon the third information 153, which may include information regarding different operations being performed on the device 150. For example, the different operations may be divided into foreground operations 411 and background operations 412. The foreground operations 411 may include one or more currently active operations, such as, accessing internet, utilizing a particular application, a phone call, and/or capturing an image or video. In some examples, the foreground operations 411 may be actually displayed on a screen of the device 150. At one particular time, only one foreground operation may be running. Meanwhile, the background operations 412 may include particular operations or processes running but invisible to a user of the device 150, dormant or invisible processes, and/or applications that are running to maintain a status of the device 150, such as certain operating system functions, printing, and/or determining a location. For example, the third information 153 may include resource allocation and/or power allocation across different operations of the device 150, performance metrics of or indicative of energy and/or data utilization and/or available energy of foreground operations compared to background operations, similar or analogous to the performance metrics described with respect to the first information 151. The third information 153 may be aggregated over a specific time period, such as, over a 24-hour time period, an hourly time period, or a weekly time period.

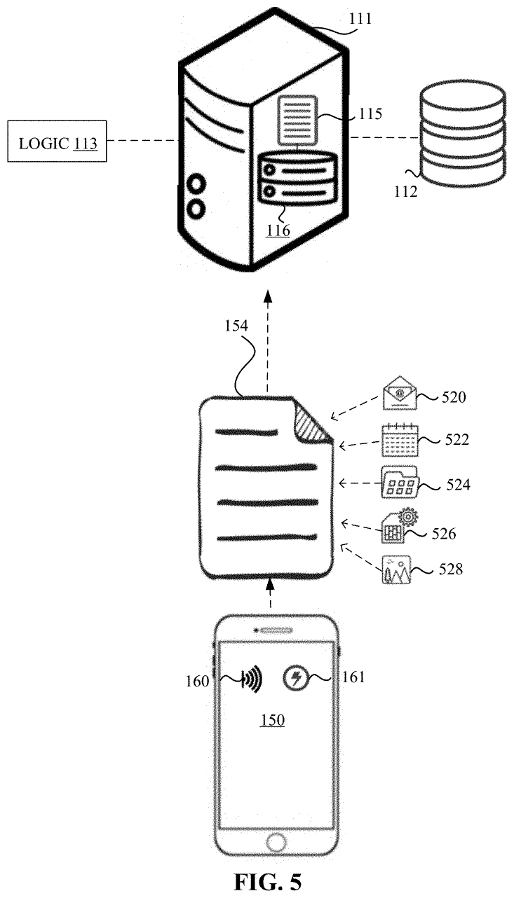

FIG. 5 elaborates upon the fourth information 154, which may include information regarding individual applications and/or processes being performed on the device 150. The fourth information 154 may include information of, or associated with, different applications and/or categories or types of applications. For example, the fourth information 154 may include information regarding messaging applications 520, information regarding organization applications 522, information regarding classification applications 524, information regarding analysis applications 526, and/or information regarding imaging or media capture applications 528, to name some examples. For example, the fourth information 154 may include resource allocation and/or power allocation across different applications and/or processes of the device 150, performance metrics of or indicative of energy and/or data utilization, similar or analogous to the performance metrics described with respect to the first information 151. The fourth information 154 may be aggregated over a specific time period, such as, over a 24-hour time period, an hourly time period, or a weekly time period.

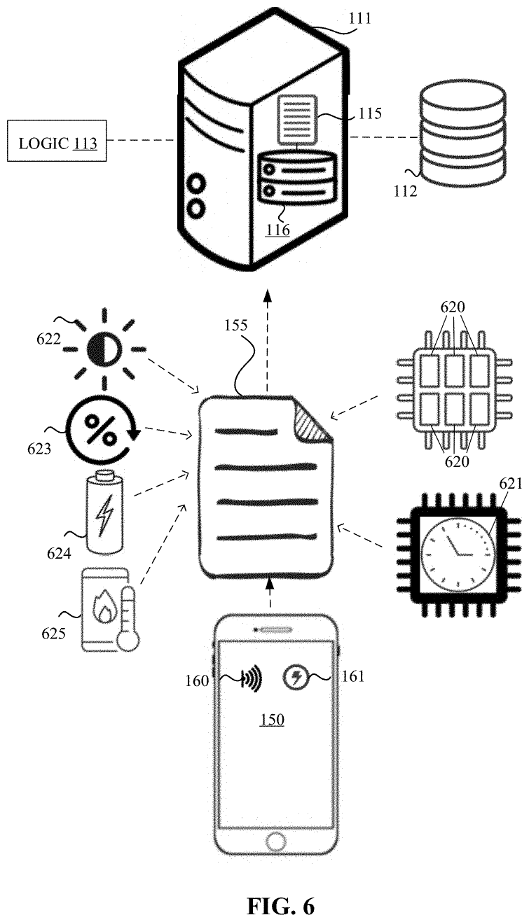

FIG. 6 elaborates upon the fifth information 155, which may include information regarding different settings on the device 150. In some examples, the fifth information 155 may encompass fixed, adjustable or variable power factors or parameters (hereinafter “power factors” collectively) which may affect power consumption or utilization of the device 150 or specific components thereof. The power factors may include a number of total, active or running cores 620 of a processor, and/or frequencies, cycles, rates at which a clock 621 of a processor (e.g., CPU, GPU, FPGA) operates or runs, and/or frame rates. Additionally, the fifth information 155 may include an operating status (e.g., on or off) of a screen or display (hereinafter “screen”), a brightness 622 of the screen and/or a refresh rate 623 of the screen. Moreover, the fifth information 155 may include a charging status 624 and/or battery level of the device 150, such as whether or not the device 150 is plugged in to an external power source or operating solely using an internal battery of the device 150. The fifth information 155 may further indicate whether the device 150 is operating under a reduced-power or power-saving mode, or a normal mode. The fifth information 155 may further include a temperature status 625 of the device 150 or a particular component of the device 150 indicating whether the device 150 or the particular component is overheating (e.g., internal temperature being outside of a threshold range of temperatures). The fifth information 155 may further include a characteristic, bandwidth, or speed of a network over which the device 150 is operating, for example, fifth generation (5G) or fourth generation (4G). The fifth information 155 may further include power factors of a WiFi component and/or a cellular component, such as transmission strengths or rates of signals, receiving strengths or rates of signals, frame or packet sizes transmitted, received, or exchanged, number of frames or packets transmitted, received, or exchanged, rates of frames or packets transmitted, received, or exchanged, or patterns or changes in such frame or packet sizes, number, or rates. The fifth information 155 may further include power factors of multimedia components, such as audio components and video components. These power factors may include audio channel parameters, volume, frame rate, bitrate, streaming rate, or resolution of audio or video components. Moreover, the fifth information 155 may include power factors of Global Navigation Satellite System (GNSS) components such as quality or accuracy level, signal collection mode, correction services, or GNSS receiver utilized. Additionally, the fifth information 155 may include power factors of DDR components such as widths of data buses, whether or not an interface is a synchronous or asynchronous enabled port such as a clock enabled port that controls the passing of data, and/or whether data bits are captured on a rising edge or falling edge of a clock.

As evident from the aforementioned examples, the power factors may be specific to a particular component of the device 150, or may be applicable to an overall operation of the device 150. The fifth information 155 may include resource allocation and/or power allocation information under different settings of the device 150.

In some examples, the computing component 111 may simultaneously collect or obtain the first information 151, the second information 152, the third information 153, the fourth information 154, and the fifth information 155 from the device 150. In response to a particular category of information being outside of threshold, or normal ranges, the computing component 111 may then collect additional information of or related to the particular category, and/or collect the additional information at more frequent intervals and/or a higher volume. For example, if a portion of the third information 153 indicates that a foreground process is operating outside of threshold ranges that indicate normal behavior, such as, consuming energy or data at a rate that exceeds a threshold range, the computing component 111 may collect additional information of or related to the third information 153, and/or the portion of the third information 153.

In other examples, the computing component 111 may initially collect or obtain the first information 151. If the first information 151 indicates that an overall operation of the device 150 is within threshold ranges indicating normal behavior, the computing component 111 may refrain from collecting the second information 152, the third information 153, the fourth information 154, and/or the fifth information 155, or collect the second information 152, the third information 153, the fourth information 154, and/or the fifth information 155 at a lower rate (e.g., less volume and/or less frequent intervals). However, if at least one parameter, metric, or indicator of the first information 151 indicates that an overall operation of the device is outside of at least one threshold range, or otherwise indicative of anomalous behavior, then the computing component 111 may collect additional information, such as, the first information 151, the second information 152, the third information 153, the fourth information 154, and/or the fifth information 155, or collect such information at a higher rate (e.g., higher volume and/or more frequent intervals). Thus, the computing component 111 may tailor or adjust the collection of information based on an operational status of the device 150, such as whether the device 150 is operating anomalously.

In some examples, the collection of any of the first information 151, the second information 152, the third information 153, the fourth information 154, and/or the fifth information 155 may be triggered at certain intervals, such as every ten minutes, every hour, every 24 hours, or every week. Alternatively, the collection of any of the first information 151, the second information 152, the third information 153, the fourth information 154, and/or the fifth information 155 may be triggered by particular events such as any metrics or parameters indicating anomalous behavior of the device 150 or a particular component, application, process, or feature thereof. Alternatively, the collection of any of the first information 151, the second information 152, the third information 153, the fourth information 154, and/or the fifth information 155 may be triggered by commencing or running of a particular application, process, feature, or component.

The computing component 111 may, using the collected information, constantly monitor behavior of the device 150 and determine one or more trends from the collected information. The computing component 111 may perform further analysis as detailed below.

As a result of the computing component 111 centrally collecting the information, including the first information 151, the second information 152, the third information 153, the fourth information 154, and/or the fifth information 155, the computing component 111 may perform different modes of analysis and/or evaluate a behavior of the device 150 from different and multiple perspectives. Therefore, the analysis is augmented by consideration of relationships and/or interactions between different components, applications, and/or settings of the device 150, rather than only testing one component of the device 150 at a time. Such a multi-perspective approach ameliorates the diagnosis and troubleshooting of an issue or problem in the device 150.

In some examples, the analysis by the computing component 111 may be triggered by certain factors, such as, in response to any of the first information 151, the second information 152, the third information 153, the fourth information 154, and/or the fifth information 155 falling outside of a threshold, and/or otherwise indicating anomalous behavior. The computing component 111 may perform analysis in any sequence or manner, such as, initially analyzing an overall operation of the device 150 using the first information. Alternatively, the computing component 111 may initially skip the first information 151 and analyze the fourth information 154 to determine an operating status of one or more particular applications. As yet another possibility, the computing component 111 may initially analyze the second information 152 to determine an operating status of one or more particular components of the device 150. Alternatively or additionally, the computing component 111 may analyze any two or more of the first information 151, the second information 152, the third information 153, the fourth information 154, and/or the fifth information 155 in parallel.

For example, the different analysis modes may include a first mode, or a ground mode, in which the computing component 111 may separate and/or analyze foreground and background operations of the device 150. The first mode may rely at least in part on the third information 153. In particular, the computing component 111 may analyze energy and/or data consumption of foreground operations and background operations. In one particular scenario, overall energy consumption of the device 150 may be within a threshold range indicating normal behavior, but one of the foreground energy consumption or the background energy consumption may be abnormally high, or outside of a threshold range. In another scenario, the computing component 111 may analyze energy and/or data consumption of a particular operation, process, or application in a foreground mode compared to a background mode to determine whether the particular operation, process, or application is behaving anomalously specifically when operating in a foreground mode or a background mode.

Meanwhile, a second mode of analysis may include a power mode, in which the computing component 111 may separate and/or analyze the information depending on a power status of the device 150, such as whether the device 150 is charging using an external power source or only operating by a battery. As another aspect, the second mode may indicate whether the device 150 is operating on a reduced-power or power-saving mode, or a normal mode. Thus, the second mode of analysis may rely at least in part on the fifth information 155.

Next, a third mode of analysis may include a screen mode, in which the computing component 111 may separate and/or analyze the information based on an operating status of a screen or other display of the device 150, for example, whether a screen or other display of the device 150 is on or off, or a brightness level of the screen. Thus, the third mode may rely at least in part on the fifth information 155.

A fourth mode of analysis may include a thermal mode, in which the computing component 111 may separate and/or analyze the information based on a temperature of the device 150 or particular components thereof. For example, the fourth mode may identify whether or not, and an extent to which, the device is overheating.

The computing component 111 may combine different modes of analysis, and/or different categories of information from the first information 151, the second information 152, the third information 153, the fourth information 154, and the fifth information 155, in order to enrich its analysis and more reliably diagnose or troubleshoot the device 150. Due to the enrichment of analysis, the computing component 111 may identify or predict particular components or factors that are causing anomalous behavior of the device 150, and/or determine linkages between different components or factors. Additionally, the computing component 111 may predict whether certain user actions are causing anomalous behavior. As a particular example, the computing component 111 may determine or analyze daily application usage, by time and energy, under different conditions, such as when the device 150 is charging compared to when the device 150 is operating on battery power. As another example, the analysis may more reliably diagnose or troubleshoot an issue or problem in the device 150. As a particular example, the computing component 111 may determine or analyze daily application usage, by time and energy, when the device 150 is overheating compared to when the device 150 is not overheating. The computing component 111 may further combine the aforementioned example analyses with a status of the screen of the device 150. For example, when the device 150 is overheating and the screen is off, while a particular application is running on the foreground, the computing component 111 may determine or predict that the particular application may be at least one reason that is causing the device 150 to overheat. By obtaining information that the screen is off, the computing component 111 may isolate certain variables or factors that may be causing anomalous behavior of the device 150. However, if the screen is on and the device 150 is overheating while a particular application is running on the foreground, the computing component 111 may determine that user behavior may be at least one reason that the device 150 is overheating. As yet another example, the computing component 111 may determine or analyze CPU utilization by time and energy consumption to determine whether the CPU utilization is causing the device 150, for example an SoC, to be overheating.

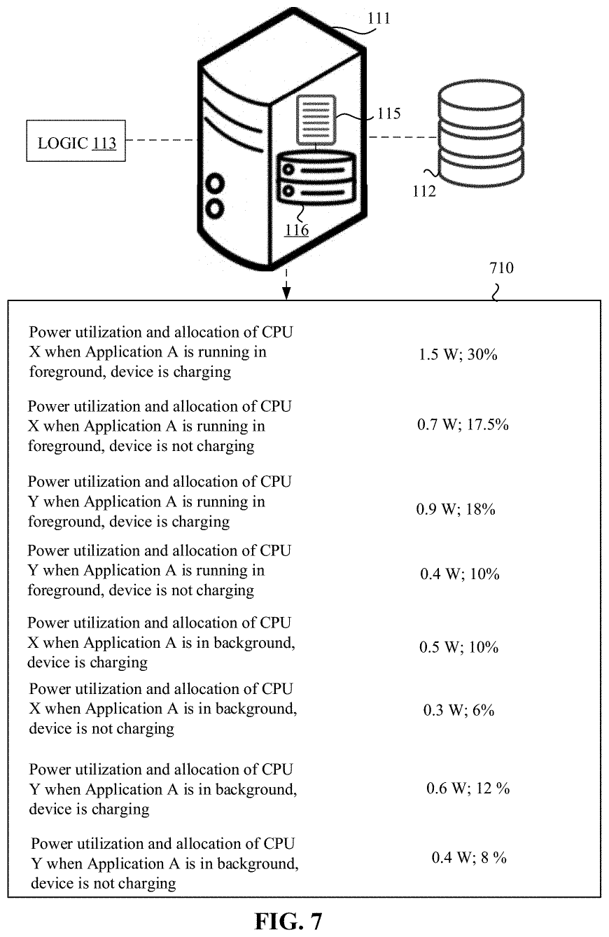

The computing component 111 may further generate a display 710 regarding the information collected, trends, and/or results of one or more analyses performed, as illustrated in FIG. 7.

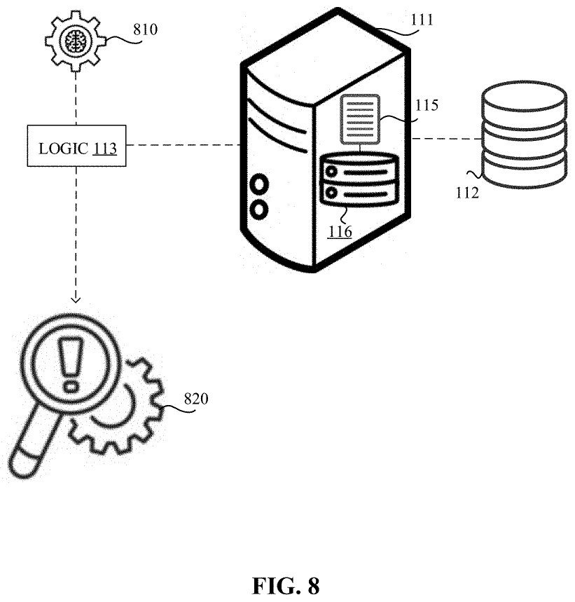

FIG. 8 illustrates a downstream analysis, predictive, troubleshooting, and/or diagnosis component 820 of the computing component 111. In FIG. 8, the component 820 may, for example, in conjunction with a machine learning component 810, further analyze, troubleshoot, and/or diagnose an anomalous behavior in the device 150 to determine one or more causes of anomalous behavior. As one example, if the device 150 is operating normally with a particular application in the foreground when operating using battery power, but abnormally or anomalously when in a charging state, the component 820 may determine, infer, or predict that the charging state may be causing the device 150 to operate anomalously, or at least when the application is in the foreground. Thus, a combination of the application running in the foreground and the charging state may be causing the anomalous operation of the device 150. Upon such determination, the component 820 may output or predict such an indication, and transmit such an indication to a different computing component that deploys a fix to the device 150, and/or itself deploys a fix to the device 150. For example, the component 820 may predict or suggest a remedial measure such as restricting a rate or amount of charging of the device 150 while the particular application is operating in the foreground, or, disable the particular application while the device 150 is charging. Additionally or alternatively, the component 820 may proactively reallocate or reschedule future tasks or operations on the device 150 to reduce a possibility of the anomalous operation of the device 150 reoccurring.

The machine learning component 810 may be trained to predict a probability of a particular cause of the device 150 behaving anomalously, and/or determine one or more corrective measures to be implemented. The prediction and determination may be based on historical data, for example, indicating particular causes and/or corrective measures, and/or an efficacy or degree to which the particular corrective measures resolved the previous anomalous behaviors. The machine learning component 810 may be trained sequentially using a first set of training data that indicated proper determinations of cause for similar extents or types of anomalous behavior, and a second set of training data that indicated improper determinations of cause for such similar extents or types of anomalous behavior. Alternatively or additionally, the machine learning component 810 may be trained sequentially using a first set of training data that indicated situations in which a particular cause was proper, and a second set of training data that indicated situations in which that particular cause was improper.

The machine learning component 810 may determine one or more corrective measures to be implemented based on a particular determined cause. For example, if a particular component or application was predicted to have caused the anomalous behavior, the machine learning component 810 may determine a specific remedy for that particular component or application, such as disabling, sequestering, or quarantining the particular component or application.

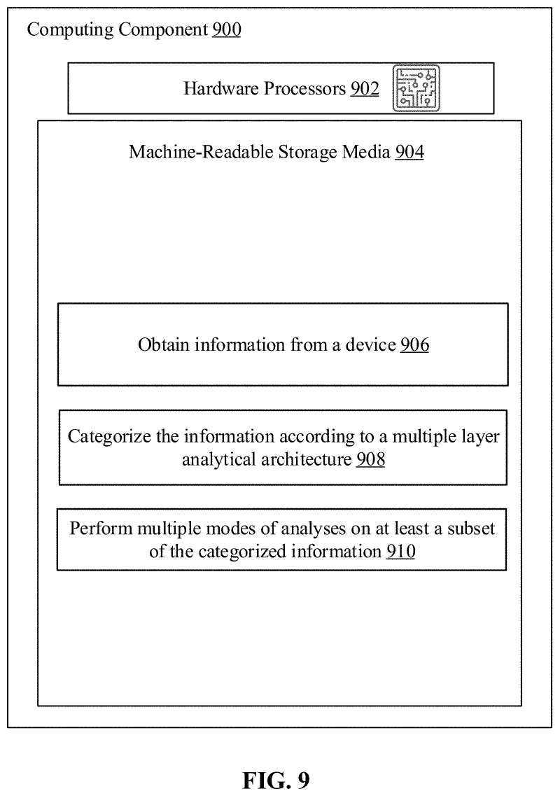

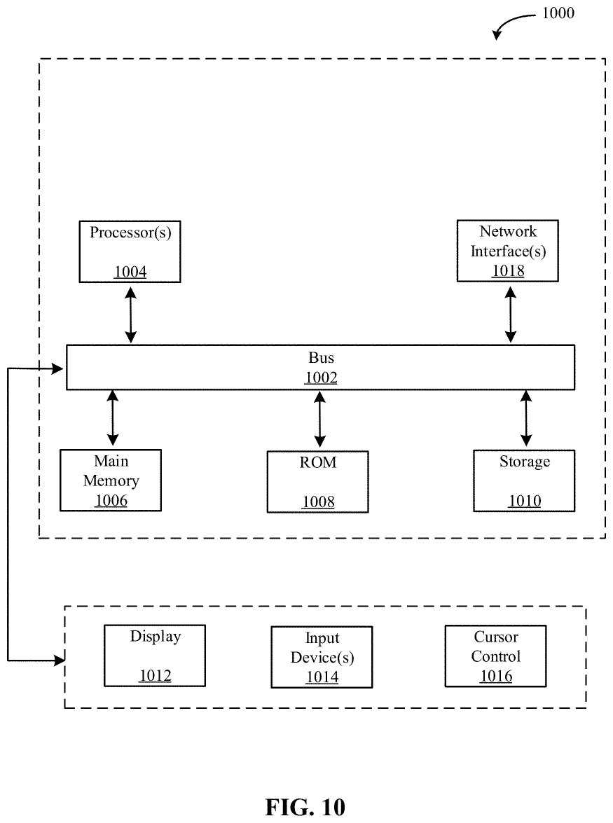

FIG. 9 illustrates a computing component 900 that includes one or more hardware processors 902 and machine-readable storage media 904 storing a set of machine-readable/machine-executable instructions that, when executed, cause the hardware processor(s) 902 to perform an illustrative method of reducing computing costs while maintaining network services and performance. It should be appreciated that there can be additional, fewer, or alternative steps performed in similar or alternative orders, or in parallel, within the scope of the various examples discussed herein unless otherwise stated. The computing component 900 may be implemented as the computing component 111 of FIGS. 1-8. The computing component 900 may include a server. The machine-readable storage media 904 may include suitable machine-readable storage media described in FIG. 10. FIG. 9 summarizes and further elaborates on some aspects previously described.

At block 906, the hardware processor(s) 902 may execute machine-readable/machine-executable instructions stored in the machine-readable storage media 904 to obtain information (e.g., the first information 151, the second information 152, the third information 153, the fourth information 154, and/or the fifth information 155) from a device (e.g., the device 150). In some examples, the information may not be categorized at the time the hardware processor(s) 902 collect or obtain the information. Thus, at block 908, the hardware processor(s) 902 may execute machine-readable/machine-executable instructions stored in the machine-readable storage media 904 to categorize, organize, cluster, or layer the information according to a multiple layer analytical architecture. The multiple layer analytical architecture may include at least a first category indicative of an overall status of the device (e.g., the first information 151) and a second category indicative of a status of a particular component, application, operation, or feature (e.g., the second information 152, the third information 153, the fourth information 154, and/or the fifth information 155), as described with respect to FIGS. 1-6.

At block 910, the hardware processor(s) 902 may execute machine-readable/machine-executable instructions stored in the machine-readable storage media 904 to perform multiple modes of analyses on at least a subset (e.g., a portion or an entirety) of the categorized information to troubleshoot or diagnose an anomalous behavior of the device. The multiple modes may include any two of the first mode, the second mode, the third mode, and the fourth mode. As a result, the hardware processor(s) 902 may perform analyses of a status of the device from multiple perspectives to isolate one or more particular causes of anomalous behavior, and/or identify linkages between different factors that may, in conjunction, cause the anomalous behavior. Therefore, due to increased granularity and perspectives from which to analyze the anomalous behavior, an efficacy and efficiency of diagnosing an anomalous behavior, or troubleshooting the device, is greatly increased. The analysis may further encompass downstream machine learning or other algorithms to more specifically predict or determine a cause of the anomalous behavior, and deploy a remedy to address the anomalous behavior, as described with respect to FIG. 8.

FIG. 10 depicts a block diagram of an example computer system 1000 in which various examples described herein may be implemented. The computer system 1000 includes a bus 1002 or other communication mechanisms for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some examples, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “component,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one example, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms, as used herein refer to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infrared data communications.

The computer system 1000 also includes a network interface 1018 coupled to bus 1002. Network interface 1018 provides a two-way data communication coupling to one or more network links that are connected to one or more local networks. For example, network interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicate with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and the Internet both use electrical, electromagnetic or optical signals that carry digital data streams. The signals through the various networks and the signals on network link and through network interface 1018, which carry the digital data to and from computer system 1000, are example forms of transmission media.

The computer system 1000 can send messages and receive data, including program code, through the network(s), network link and network interface 1018. In the Internet example, a server might transmit a requested code for an application program through the Internet, the ISP, the local network and the network interface 1018. The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computer processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such descriptions shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it was individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

What is claimed is:

1. A computer-implemented method, comprising:
categorizing, according to a multiple layer analytical architecture, information obtained from a device, wherein the information indicative of a status of the device, the multiple layer analytical architecture comprises a first category indicative of an overall status of the device and a second category indicative of a status of a particular component, application, operation, or feature; and
performing multiple modes of analyses on at least a subset of the categorized information to troubleshoot or diagnose an anomalous behavior of the device.

2. The computer-implemented method of claim 1, wherein the second category is indicative of a status of a particular component; and the multiple layer analytical architecture further comprises a third category indicative of a status of a particular operation of the device, the status of the particular operation being indicative of a foreground or a background status of a particular application or process running on the device.

3. The computer-implemented method of claim 2, wherein the multiple layer analytical architecture further comprises a fourth category indicative of a power or data utilization of the particular application or process.

4. The computer-implemented method of claim 3, wherein the multiple layer analytical architecture further comprises a fifth category indicative of a particular variable setting of the device.

5. The computer-implemented method of claim 4, wherein the particular variable setting comprises a number of cores running on a central processing unit (CPU) or a frequency of a clock of the CPU.

6. The computer-implemented method of claim 4, wherein the particular variable setting comprises a degree of brightness or a refresh rate of a screen or display of the device.

7. The computer-implemented method of claim 1, wherein performing the multiple modes of analyses comprises performing analyses according to at least two of a first mode, a second mode, a third mode, and a fourth mode, wherein:
the first mode is based on a foreground or background status of one or more applications or processes;
the second mode is based on a power charging status of the device;
the third mode is based on a status of a screen or display of the device; and
the fourth mode is based on a temperature of the device.

8. The computer-implemented method of claim 7, wherein performing the multiple modes of analyses comprises performing analyses according to at least the second mode, wherein the power charging status is indicative of whether the device is charging using an external power source or consuming an internal battery of the device without charging using an external power source.

9. The computer-implemented method of claim 7, wherein performing the multiple modes of analyses comprises performing analyses according to at least the third mode, wherein the status of the screen or display indicates whether the screen or display is on or off.

10. The computer-implemented method of claim 7, wherein performing the multiple modes of analyses comprises performing analyses according to at least the fourth mode, wherein the temperature of the device indicates whether the device is overheating.

11. A computing system comprising:
one or more processors; and
a memory storing instructions that, when executed by the one or more processors, cause the one or more processors to:
obtain information from a device, the information indicative of a status of the device and being aggregated over a preset time period;
categorize the information according to a multiple layer analytical architecture, wherein the multiple layer analytical architecture comprises a first category indicative of an overall status of the device and a second category indicative of a status of a particular component, application, operation, or feature; and
perform multiple modes of analyses on at least a subset of the categorized information to troubleshoot or diagnose an anomalous behavior of the device.

12. The computing system of claim 11, wherein the second category is indicative of a status of a particular component; and the multiple layer analytical architecture further comprises a third category indicative of a status of a particular operation of the device, the status of the particular operation being indicative of a foreground or a background status of a particular application or process running on the device.

13. The computing system of claim 12, wherein the multiple layer analytical architecture further comprises a fourth category indicative of a power or data utilization of the particular application or process.

14. The computing system of claim 13, wherein the multiple layer analytical architecture further comprises a fifth category indicative of a particular variable setting of the device.

15. The computing system of claim 14, wherein the particular variable setting comprises a number of cores running on a central processing unit (CPU) or a frequency of a clock of the CPU.

16. The computing system of claim 14, wherein the particular variable setting comprises a degree of brightness or a refresh rate of a screen or display of the device.

17. The computing system of claim 11, wherein performing the multiple modes of analyses comprises performing analyses according to at least two of a first mode, a second mode, a third mode, and a fourth mode, wherein:
the first mode is based on a foreground or background status of one or more applications or processes;
the second mode is based on a power charging status of the device;
the third mode is based on a status of a screen or display of the device; and
the fourth mode is based on a temperature of the device.

18. A non-transitory storage medium storing instructions that, when executed by at least one processor of a computing system, cause the computing system to perform a method comprising:
obtaining information from a device, the information indicative of a status of the device and being collected at the device in response to a particular event;
categorizing the information according to a multiple layer analytical architecture, wherein the multiple layer analytical architecture comprises a first category indicative of an overall status of the device and a second category indicative of a status of a particular component, application, operation, or feature; and
performing multiple modes of analyses on at least a subset of the categorized information to troubleshoot or diagnose an anomalous behavior of the device.

19. The non-transitory storage medium of claim 18, wherein the second category is indicative of a status of a particular component; and the multiple layer analytical architecture further comprises a third category indicative of a status of a particular operation of the device, the status of the particular operation being indicative of a foreground or a background status of a particular application or process running on the device.

20. The non-transitory storage medium of claim 18, wherein performing the multiple modes of analyses comprises performing analyses according to at least two of a first mode, a second mode, a third mode, and a fourth mode, wherein:
the first mode is based on a foreground or background status of one or more applications or processes;
the second mode is based on a power charging status of the device;
the third mode is based on a status of a screen or display of the device; and
the fourth mode is based on a temperature of the device.
